(19) United States
(12) Patent Application Publication
(10) Pub. No.: US 2014/0286300 A1
(43) Pub. Date: Sep. 25, 2014

(54) METHOD AND APPARATUS FOR DETERMINING A BACKOFF FACTOR VALUE IN A MOBILE COMMUNICATION SYSTEM

(71) Applicant: Samsung Electronics Co., Ltd., Gyeonggi-do (KR)

(72) Inventors: Yun-Seok Choi, Daegu (KR); Jae-Hee Cho, Seoul (KR)

(21) Appl. No.: 14/359,082

(22) PCT Filed: Nov. 14, 2012
(86) PCT No.: PCT/KR2012/009587

§ 371 Date: May 16, 2014

(30) Foreign Application Priority Data
Nov. 17, 2011 (KR) 10-2011-0120183

(51) Int. Cl. H04W 72/04; H04B 7/12

(52) U.S. Cl. CPC H04W 72/0453; H04B 7/12
USPC 370/329

(57) ABSTRACT

In a mobile communication system, a serving base station receives, from at least one neighboring base station, beamforming information including information about a frame period in which data is transmitted using frequency band-specific beamforming, determines, based on the received beamforming information, whether a beamforming transmit mode of the at least one neighboring base station is a nulling mode in which null data is transmitted to at least one of mobile terminals included in a cell of the serving base station, determines whether a response signal received from the at least one mobile terminal is generated by an interference signal of the at least one neighboring base station, if the beamforming transmit mode of the at least one neighboring base station is the nulling mode, and determines whether to update a backoff factor value based on a result of the determination.

### TECHNICAL FIELD

The present disclosure relates to a method and apparatus for determining a backoff factor value in a mobile communication system.

### BACKGROUND ART

A downlink beamforming scheme refers to a scheme in which in a mobile communication system, a base station forms a beam based on channel information fed back from mobile terminals to transmit data. The downlink beamforming scheme may be used based on multiple antennas to improve the reliability of the mobile communication system and increase the capacity of the mobile communication system.

The downlink beamforming scheme includes a maximal ratio transmission (MRT) scheme for maximizing a received signal strength from a serving base station and a nulling scheme for minimizing a strength of an interference signal transmitted to an interference cell. When the nulling scheme is used for a mobile terminal that exists in a cell edge region where the strength of the interference signal is high, the interference signal is removed such that a carrier to interference and noise ratio (CINR) and a system capacity gain that are higher than when the MRT scheme is used may be obtained.

In a mobile communication system, the nulling scheme may not be used instantly due to transmission of a broadcast message having a high priority in a short frame period in the interference cell during the use of the nulling scheme. As a result, in a serving cell, the strength of the interference signal is increased during the non-use of the nulling scheme in the interference cell, and data the mobile terminal in the serving cell has received may include some errors.

The serving base station reduces a backoff factor value based on a negative acknowledgment (NACK) signal transmitted by the mobile terminal in the serving cell, and as a result, a modulation and coding scheme (MCS) level of the mobile terminal may be lowered. Even if the nulling scheme for the interference cell is used again afterwards, some time is consumed to raise the MCS level lowered by the reduction in the backoff factor value, and system capacity is degraded during the consumed time.

### DISCLOSURE

### Technical Problem

An aspect of the present disclosure is to provide a method and apparatus for determining a backoff factor value in a mobile communication system.

Another aspect of the present disclosure is to provide a method and apparatus for determining a backoff factor value to prevent system capacity degradation in a mobile communication system.

Another aspect of the present disclosure is to provide a method and apparatus for determining a backoff factor value in a mobile communication system, in which a base station periodically monitors based on beamforming information received from a neighboring base station whether a nulling scheme is used in the neighboring base station, thereby solving the problem of carrier to interference and noise ratio (CINR) degradation occurring when the nulling scheme is not used in the neighboring base station.

### Technical Solution

In accordance with an embodiment of the present disclosure, there is provided a method for determining a backoff factor value of a serving base station in a mobile communication system, the method including receiving, from at least one neighboring base station, beamforming information including information about a frame period in which data is transmitted using frequency band-specific beamforming, determining, based on the received beamforming information, whether a beamforming transmit mode of the at least one neighboring base station is a nulling mode in which null data is transmitted to at least one of mobile terminals included in a cell of the serving base station, determining whether a response signal received from the at least one mobile terminal is generated by an interference signal of the at least one neighboring base station, if the beamforming transmit mode of the at least one neighboring base station is the nulling mode, and determining whether to update a backoff factor value based on a result of the determination.

In accordance with another embodiment of the present disclosure, there is provided a method for transmitting and receiving beamforming information by a neighboring base station in a mobile communication system, the method including transmitting to a serving base station, first beamforming information including information about a frame period in which the neighboring base station transmits data by using frequency band-specific beamforming and receiving from the serving base station, second beamforming information including information about a frame period in which the serving base station transmits data by using the frequency band-specific beamforming.

In accordance with another embodiment of the present disclosure, there is provided a serving base station in a mobile communication system, the serving base station including a transmitter, a receiver, a base station interface configured to receive beamforming information including information regarding a period from at least one neighboring base station, and a controller configured to determine, based on the received beamforming information, whether a beamforming transmit mode of the at least one neighboring base station is a nulling mode in which null data is transmitted to at least one of mobile terminals included in a cell of the serving base station, determine whether a response signal received from the at least one mobile terminal is generated by an interference signal of the at least one neighboring base station, if the beamforming transmit mode of the at least one neighboring base station is the nulling mode, and determine whether to update a backoff factor value based on a result of the determination.

In accordance with another embodiment of the present disclosure, there is provided a neighboring base station in a mobile communication system, the neighboring base station including a base station interface configured to transmit to a serving base station, first beamforming information including information about a frame period in which the neighboring base station transmits data by using frequency band-specific beamforming, and to receive from the serving base station, second beamforming information including information about a frame period in which the serving base station transmits data by using the frequency band-specific beamforming.

### Advantageous Effects

According to the present disclosure, in the mobile communication system, the base station may periodically monitor, based on the beamforming information received from the neighboring base station, whether the nulling scheme is used in the neighboring base station. Moreover, the present disclosure may solve the CINR degradation problem that occurs due to the reduction in the backoff factor value when the nulling scheme is not used in the neighboring base station.

### DESCRIPTION OF DRAWINGS

FIG. 1 is a signal flow illustrating a process of transmitting and receiving data between a base station and a mobile terminal in a general mobile communication system;

FIG. 2 is a diagram illustrating a structure of a mobile communication system according to an embodiment of the present disclosure;

FIG. 3 is a flowchart illustrating a process in which a serving base station determines a backoff factor value in a mobile communication system according to an embodiment of the present disclosure;

FIG. 4 is a flowchart illustrating a process in which a serving base station determines a nulling mode in a mobile communication system according to an embodiment of the present disclosure;

FIG. 5 is a flowchart illustrating a process in which a neighboring base station transmits beamforming information according to an embodiment of the present disclosure; and

FIG. 6 is a block diagram of a serving base station in a mobile communication system according to an embodiment of the present disclosure.

### BEST MODE

Hereinafter, an embodiment of the present disclosure will now be described in detail with reference to the accompanying drawings. In describing the present disclosure, when a detailed description of the known functions or structures is determined to unnecessarily obscure the subject matter of the present disclosure the detailed description will be omitted.

The present disclosure proposes a method and apparatus for determining a backoff factor value in a mobile communication system. More specifically, the present disclosure proposes a method and apparatus for determining a backoff factor value in a mobile communication system, in which it is detected based on beamforming information exchanged between base stations whether a nulling scheme is used in a neighboring base station and system capacity degradation is prevented.

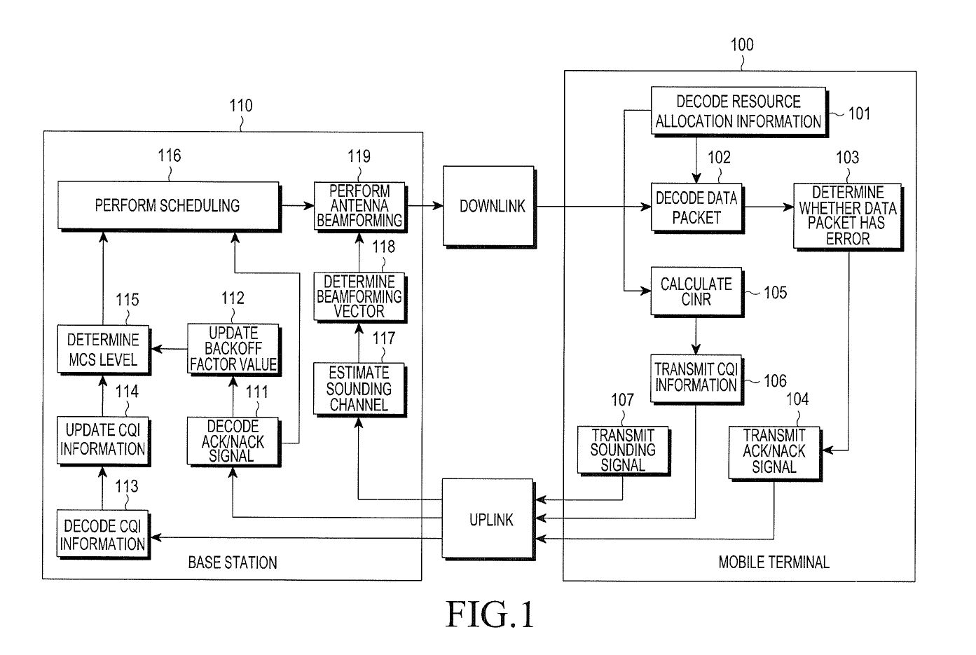

Prior to a description of an embodiment of the present disclosure, a process of transmitting and receiving data between a base station and a mobile terminal in a general mobile communication system will be described with reference to FIG. 1.

FIG. 1 is a signal flow diagram illustrating a process of transmitting and receiving data between a base station and a mobile terminal in a general mobile communication system.

A mobile terminal 100 operates as described below.

The mobile terminal 100 receives resource allocation information (for example, a MAP message) from a base station 110 through a downlink to perform decoding, in operation 101. The mobile terminal 100 receives data transmitted in the unit of a packet (hereinafter, referred to as a ‘data packet’) based on the resource allocation information, and decodes the received data packet in operation 102. The mobile terminal 100 determines whether the decoded data packet has an error in operation 103, and transmits one of an acknowledgement (ACK) signal and a negative acknowledgement (NACK) signal to the base station 110 based on the determination result in operation 104.

The mobile terminal 100 calculates a carrier to interference and noise ratio (CINR) based on a preamble signal received from the base station 110 in operation 105. The mobile terminal 100 generates channel quality indicator (CQI) information based on information about the calculated CINR, quantizes the generated CQI information, and transmits the quantized CQI information to the base station 110 in operation 106.

The mobile terminal 100 transmits to the base station 110, a sounding signal that allows the base station 110 to estimate a channel for the mobile terminal 100 and to perforin beamforming, in operation 107.

Next, the base station 110 operates as described below.

The base station 110 transmits a data packet to the mobile terminal 100 and receives one of an ACK signal and a NACK signal corresponding to the transmitted data packet from the mobile terminal 100 through an uplink to perform decoding in operation 111. The base station 110 updates a previously stored backoff factor value by using a value corresponding to the decoded signal in operation 112. That is, the backoff factor value may be updated as described below.

If receiving the NACK signal, the base station 110 reduces the backoff factor value by a predetermined first value (for example, 0.5 dB). If receiving the ACK signal, the base station 110 increases the backoff factor value by a predetermined second value. The second value may be calculated like “first value/(1/target PER−1)”, and for example, if the first value is “0.5 dB” and the target PER is “10%”, the second value may be “0.5/9 dB”.

If receiving CQI information from the mobile terminal 100, the base station 110 decodes the CQI information in operation 113. The base station 110 updates previously stored CQI information for the mobile terminal 100, based on the decoded CQI information in operation 114. In operation 115, the base station 110 determines an MCS level by using the updated CQI information and the backoff factor value updated in operation 112. More specifically, the MCS level is determined using Equation (1) provided below.

MCS=f(CQI+backoff−factor) (1),

wherein “MCS” represents the MCS level, “CQI” represents the updated CQI information, and “backoff-factor” represents the updated backoff factor value.

The base station 110 determines data to be transmitted to the mobile terminal 100, by using the determined MCS level, and performs a scheduling process of allocating a resource for the mobile terminal 100, in operation 116. The base station 110 forms an antenna beam to transmit the data to the mobile terminal 100 in the unit of a packet in operation 119. A beamforming vector used at this time may be determined as follows. If receiving the sounding signal, the base station 110 estimates a channel by using the sounding signal in operation 117, and deter nines the beamforming vector by using the estimated channel in operation 118.

As stated above, in the conventional mobile communication system, a reduction in the backoff factor value in reception of the NACK signal is larger than an increase in the backoff factor value in reception of the ACK signal. Thus, if the nulling scheme is not used due to transmission of a broadcast message having a high priority during a short frame period in a neighboring cell, a problem may be caused by interference.

That is, in case of the non-use of the nulling scheme in which a signal transmitted from the neighboring cell is received as null data by a mobile terminal in another cell, instead of as an interference signal, interference from the neighboring cell increases, such that the mobile terminal 100 may not accurately receive a packet data and transmits a corresponding NACK signal to the base station 110, resulting in the reduction in the backoff factor value.

Since the MCS level is proportional to the backoff factor value, the reduction in the backoff factor value leads to the lowering of the MCS level, thus reducing the CINR gain. In spite of the subsequent use of the nulling scheme, some time is needed to raise the MCS level lowered by the reduction in the backoff factor value, and system capacity is degraded during that time.

Therefore, to solve such problems, an embodiment of the present disclosure proposes a scheme for transmitting and receiving beamforming-related information between base stations and determining a backoff factor value based on the beamforming-related information.

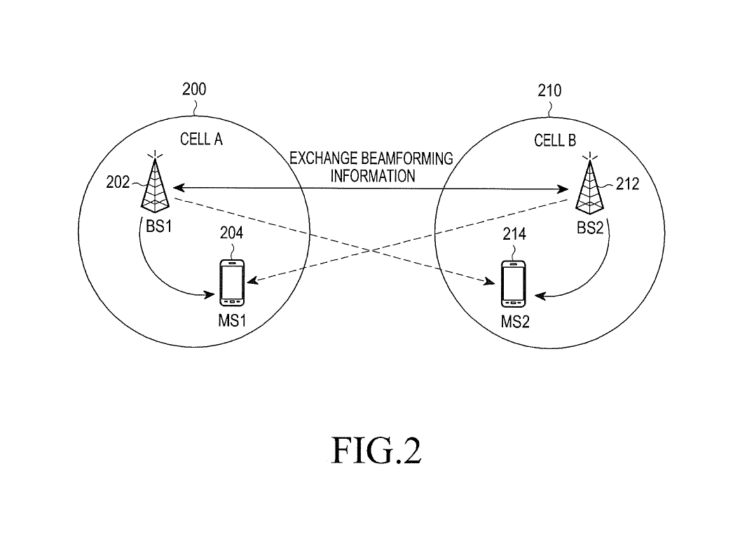

Hereinafter, a structure of a mobile communication system according to an embodiment of the present disclosure will be described with reference to FIG. 2.

FIG. 2 is a diagram illustrating a structure of a mobile communication system according to an embodiment of the present disclosure.

Referring to FIG. 2, the mobile communication system may include multiple cells, and in FIG. 2, the mobile communication system includes two cells as an example. Among the two cells, a cell A 200 includes a first base station BS1 202 at least one mobile terminal (for example, a first mobile terminal MS1 204) that receives a service from the first base station 202, and the cell B 210 includes a second base station BS2 212 and at least one mobile terminal (for example, a second mobile terminal MS2 214) that receives a service from the second base station 212.

The first base station 202 and the second base station 212 use the nulling scheme to prevent an interference signal from arriving at the cell B 210 and the cell A 200. That is, the first base station 202 operates as described below such that a signal is transmitted to the first mobile terminal 204 included in the cell 200 of the first base station 202 and the signal is not received by the second mobile terminal 214 that receives a service from the second base station 212.

The first base station 202 operates such that a signal transmitted to the first mobile terminal 204 is received as null data by the second mobile terminal 214, and is not received as an interference signal by the second mobile terminal 214. That is, the first base station 202 receives a sounding signal transmitted from the second mobile terminal 214 to estimate a channel used by the second mobile terminal 214, and transmits the null data to the second mobile terminal 214 through the estimated channel.

The second base station 212 operates as described below, so that a signal is transmitted to the second mobile terminal 214 included in the cell 210 of the second base station 212 and the signal is not received by the first mobile terminal 204 that receives a service from the first base station 202.

The second base station 212 operates such that a signal transmitted to the second mobile terminal 214 is received as null data by the first mobile terminal 204, and is not received as an interference signal by the first mobile terminal 204. That is, the second base station 212 receives a sounding signal transmitted from the first mobile terminal 204 to estimate a channel used by the first mobile terminal 204, and transmits the null data to the first mobile terminal 204 through the estimated channel.

The first base station 202 and the second base station 212 exchange beamforming information every frame or at preset frame intervals. The beamforming information may be transmitted and received through a preset interface (for example, an interface using software) between the first base station 202 and the second base station 212.

The beamforming information may include a base station identifier (ID) and transmit resource-specific beamforming use information. For example, the beamforming use information may include a frame period in which data is transmitted using frequency band-specific beamforming. For a mobile communication system in which partial usage of subchannel (PUSC) is used, the beamforming use information may include 1-bit information indicating whether data is transmitted using cluster-specific beamforming.

The first base station 202 and the second base station 212 determine using the exchanged beamforming information whether a nulling scheme is used in its neighboring base station for mobile terminals included in its cell, and determines based on the determination result whether to update the backoff factor value to prevent the reduction of the CINR gain.

A description will now be made of the method for determining the backoff factor value based on the beamforming information transmitted and received between base stations.

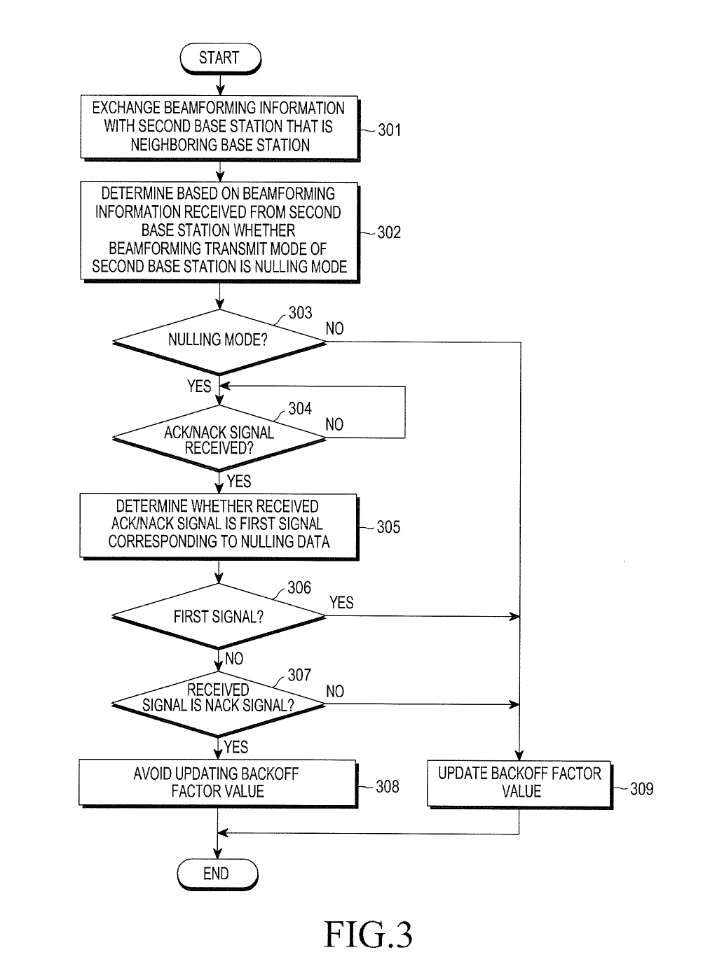

FIG. 3 is a flowchart illustrating a process in which a serving base station determines a backoff factor value in the mobile communication system according to an embodiment of the present disclosure. To help understanding, in FIG. 3, a description will be made using an example where the first base station 202 illustrated in FIG. 2 is the serving base station.

Referring to FIG. 3, the first base station 202 exchanges beamforming information with the second base station 212, which is a neighboring base station, every frame or at preset frame intervals in operation 301. In operation 302, the first base station 202 determines based on the beamforming information received from the second base station 212 whether a beamforming transmit mode of the second base station 212 for at least one mobile terminal 204 among mobile terminals included in a cell of the first base station 202 is a nulling mode in a particular frame period or at a particular frame point in time.

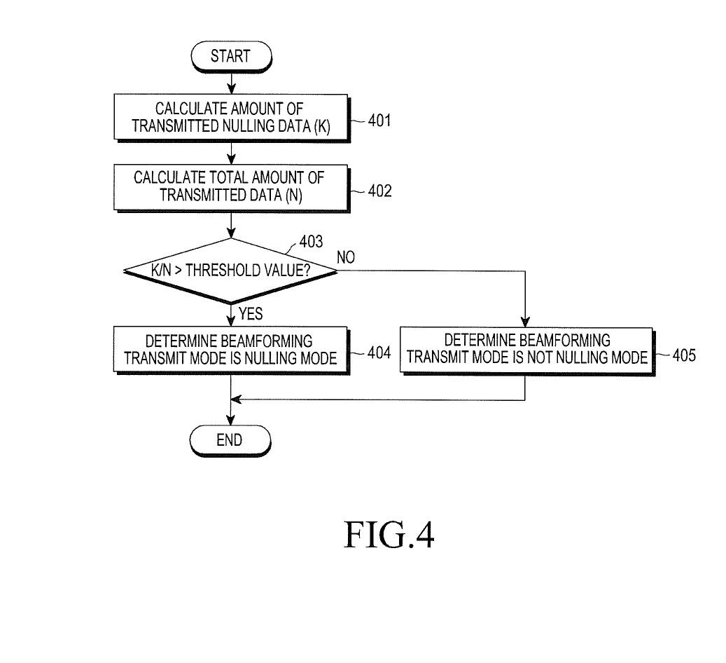

This process is executed to identify the at least one mobile terminal 204 that receives data for which nulling is performed to remove an interference signal from the second base station 212 (hereinafter, referred to as ‘nulling data’) among the mobile terminals included in the cell of the first base station 202. The process in which the first base station 202 determines whether the beamforming transmit mode of the second base station 212 is the nulling mode will be described in detail with reference to FIG. 4.

If determining that the beamforming transmit mode of the second base station 212 is the nulling mode in operation 303, the first base station 202 goes to operation 304 to determine whether an ACK signal or a NACK signal is received from the at least one mobile terminal 204. If receiving the ACK signal or the NACK signal, the first base station 202 determines whether the received ACK signal or NACK signal is a first signal corresponding to the nulling data in operation 305.

The nulling data is data received by the at least one mobile terminal 204 from the second base station 212 if the second base station 212 performs beamforming transmission in the nulling mode. The first base station 202 may determine data transmitted by the second base station 212 in a first frequency band among multiple frequency bands as the nulling data in an overlapping frame period between a first frame period in which the first base station 202 transmits data using beamforming in the first frequency band and a second frame period in which the second base station 212 transmits data using beamforming in the first frequency band.

In a mobile communication system using PUS C, if the same clusters as all the clusters allocated to a mobile terminal are used for beamforming transmission in all the neighboring base stations, and the same clusters as all the clusters allocated to the mobile terminal are used for beamforming transmission in a serving base station, data received by the mobile terminal may be determined as the nulling data.

The foregoing process is performed for the first base station 202 to determine whether the second base station 212 performs beamforming transmission in the nulling mode or not. If the second base station 212 does not perform beamforming transmission in the nulling mode, a signal transmitted from the second base station 212 affects the at least one mobile terminal 204 as an interference signal. Thus, the at least one mobile terminal 204 may not accurately receive data transmitted from the first base station 202.

The second base station 212 performs beamforming transmission in the nulling mode, but may not perform beamforming transmission in the nulling mode for broadcast message transmission. However, a frame period in which the second base station 212 does not perform beamforming transmission in the nulling mode is not long, such that if the reduction in the backoff factor value due to the NACK signal caused by the interference signal of the second base station 212 is prevented, degradation of the CINR may be prevented.

If determining that the received ACK signal or NACK signal is the first signal in operation 306, the first base station 202 determines that the second base station 212 performs beamforming transmission in the nulling mode and goes to operation 309. The first base station 202 performs a general process of updating the backoff factor value in operation 309. That is, the first base station 202 determines whether the ACK signal or NACK signal is received for the transmitted data, and updates the backoff factor value by a value corresponding to the ACK signal or NACK signal based on the determination result.

If determining that the received ACK signal or NACK signal is not the first signal in operation 306, the first base station 202 determines that the second base station 212 does not perform beamforming transmission in the nulling mode and goes to operation 307. The first base station 202 determines whether the received signal is the NACK signal in operation 307. If the received signal is the NACK signal, the first base station 202 goes to operation 308 not to update the backoff factor value.

That is, the first base station 202 determines that the NACK signal caused by the interference signal of the second base station 212 is the NACK signal temporarily generated by instantaneous CINR degradation. More specifically, the first base station 202 determines that the nulling scheme may not be used by the second base station 212 in a particular frame period because of broadcast message transmission (that is, nulling data may not be transmitted to the at least one mobile terminal), and does not update the backoff factor value to prevent CINR degradation caused by the non-use of the nulling scheme.

If the received signal is the ACK signal, the first base station 202 goes to operation 309 to update the backoff factor value. That is, the first base station 202 updates the backoff factor value by a predetermined value corresponding to the ACK signal.

Referring to FIG. 4, a detailed description will now be made of operation 302 of FIG. 3.

FIG. 4 is a flowchart illustrating a process in which a serving base station determines the nulling mode in the mobile communication system according to an embodiment of the present disclosure. In FIG. 4, a description will be made using an example where the first base station 202 illustrated in FIG. 2 is the serving base station.

Referring to FIG. 4, the first base station 202 calculates an amount of nulling data transmitted in a particular frame period, a nulling data amount K, for each of or one of mobile terminals included in a cell of the first base station 202 in operation 400. Herein, the particular frame period may be a preset frame period or a frame period that is arbitrarily set by the first base station 202. The nulling data amount indicates the amount of data transmitted by the first base station 202 to the mobile terminal in the same frame period as a frame period in which at least one neighboring base station, for example, the second base station 212 transmits data, by using the same frequency band as used by the second base station 212. The nulling data amount may be calculated based on the beamforming information received from the second base station 212.

The first base station 202 calculates a total amount of data transmitted to the mobile terminal in the particular frame interval, a total data amount N, in operation 402. The first base station 202 goes to operation 403 to calculate a ratio of the nulling data amount K to the total data amount N (that is, K/N) and compare the ratio with a threshold value.

If K/N is greater than the threshold value, the first base station 202 goes to operation 404 to determine that the mobile terminal exists in the nulling mode. If K/N is not greater than the threshold value, the first base station 202 goes to operation 405 to determine that the mobile terminal does not exist in the nulling mode.

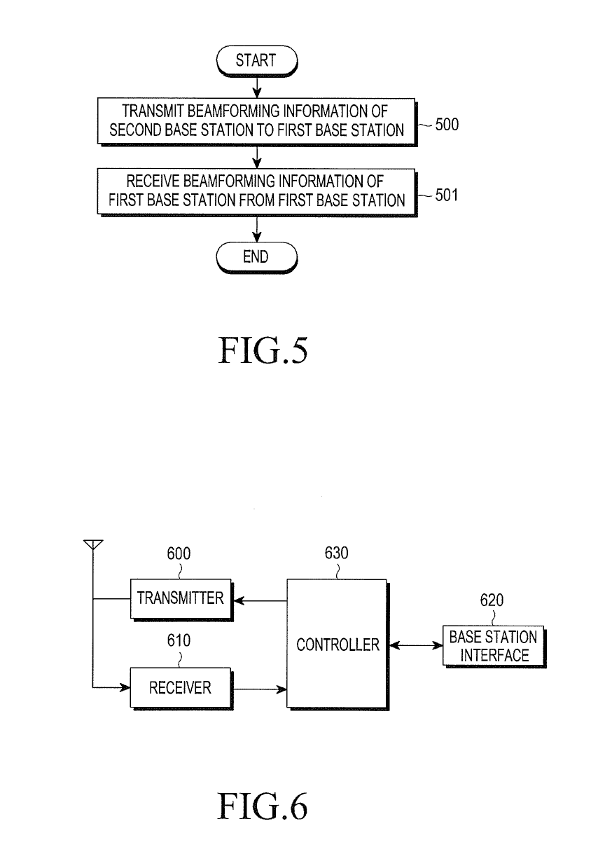

Next, FIG. 5 is a flowchart illustrating a process in which a neighboring base station transmits beamforming information according to an embodiment of the present disclosure. In FIG. 5, a description will be made using an example where the neighboring base station is the second base station 212 illustrated in FIG. 2 and the serving base station is the first base station 202.

Referring to FIG. 5, the second base station 212 transmits beamforming information of the second base station 212 to the first base station 202 in operation 500. The beamforming information of the second base station 212 includes a base station ID of the second base station 212 and information indicating a frame period in which the second base station 212 transmits data by using frequency band-specific beamforming.

The second base station 212 receives beamforming information from the first base station 202 in operation 501. The beamforming information of the first base station 202 includes a base station ID of the first base station 202 and information indicating a frame period in which the first base station 202 transmits data by using frequency band-specific beamforming.

The beamforming information of the second base station 212 may be transmitted to the first base station 202, if a request message requesting provisioning of the beamforming information of the second base station 212 is received from the first base station 202 or at preset frame intervals. The beamforming information of the first base station 202 may be received, if a request message requesting provisioning of the beamforming information of the first base station 202 is transmitted to the first base station 202, or at predetermined intervals.

Next, a structure of a serving base station according to an embodiment of the present disclosure will be described with reference to FIG. 6.

FIG. 6 is a block diagram illustrating a serving base station in a mobile communication system according to an embodiment of the present disclosure.

Referring to FIG. 6, the serving base station may include a transmitter 600, a receiver 610, a base station interface 620, and a controller 630.

The transmitter 600 and the receiver 610 are components for performing wireless communication with at least one mobile terminal. The transmitter 600 transmits data to the at least one mobile terminal, and the receiver 610 receives an ACK signal or NACK signal corresponding to the transmitted data.

The base station interface 620 allows the serving base station to exchange beamforming information with neighboring base stations. The controller 630 controls the transmitter 600, the receiver 610, and the base station interface 620 to control the overall operation of the serving base station. In particular, the controller 630 performs operations corresponding to FIGS. 3 and 4 described above, thereby performing a backoff factor value determining process proposed in the embodiment of the present disclosure.

A structure of a neighboring base station proposed in the embodiment of the present disclosure is similar with that of the serving base station illustrated in FIG. 7. The neighboring base station may include the transmitter, the receiver, the controller, and the base station interface that performs the process illustrated in FIG. 5. The neighboring base station may also perforin operations that are similar to those of the serving base station and such operations may be controlled by the controller.

While a detailed embodiment has been described in the detailed description of the present disclosure, various modifications may be possible without departing from the scope of the present disclosure. Therefore, the scope of the present disclosure should not be defined by the described embodiment, and should be defined by the appended claims and equivalents thereof.

1. A method for determining a backoff factor value of a serving base station in a mobile communication system, the method comprising:
receiving, from at least one neighboring base station, beamforming information including information about a frame period in which data is transmitted using frequency band-specific beamforming;
determining, based on the received beamforming information, whether a beamforming transmit mode of the at least one neighboring base station is a nulling mode in which null data is transmitted to at least one of mobile terminals included in a cell of the serving base station;
determining whether a response signal received from the at least one mobile terminal is generated by an interference signal of the at least one neighboring base station, if the beamforming transmit mode of the at least one neighboring base station is the nulling mode; and
determining whether to update a backoff factor value based on a result of the determination.

2. The method of claim 1, wherein the determining of whether the beamforming transmit mode is the nulling mode comprises:
calculating a first data amount indicating a total amount of data transmitted to the at least one mobile terminal in a first frame period in a first frequency band among multiple frequency bands;
calculating a second data amount indicating an amount of data transmitted to the at least one mobile terminal in a fourth frame period, which is an overlapping frame period between a second frame period in which the serving base station transmits data by using the beamforming in the first frequency band and a third frame period in which the at least one neighboring base station transmits data by using the beamforming in the first frequency band;
determining a ratio of the second data amount to the first data amount; and
determining whether the beamforming transmit mode of the at least one neighboring base station is the nulling mode, according to whether the ratio of the second data amount to the first data amount is greater than a threshold value,
wherein the fourth frame period is included in the first frame period.

3. The method of claim 2, wherein the determining of whether the response signal is generated by the interference signal of the at least one neighboring base station comprises:
determining that a negative acknowledgement (NACK) signal is generated due to the interference signal of the at least one neighboring base station, if the response signal is the NACK signal corresponding to data transmitted in a fifth frame interval that is the remaining frame interval of the first frame interval except for the fourth frame interval.

4. The method of claim 1, wherein the determining of whether to update the backoff factor value comprises:
determining not to update the backoff factor value if determining that the response signal is generated by the interference signal of the at least one neighboring base station.

5. The method of claim 1, further comprising:
determining to update the backoff factor value by a preset value corresponding to an acknowledgement (ACK) signal, if the response signal is the ACK signal.

6. The method of claim 1, wherein the beamforming information received from the at least one neighboring base station further comprises a base station identifier (ID) of the at least one neighboring base station.

7. A serving base station in a mobile communication system, the serving base station comprising:
a transmitter;
a receiver;
a base station interface configured to receive beamforming information including information regarding a period from at least one neighboring base station; and
a controller configured to determine, based on the received beamforming information, whether a beamforming transmit mode of the at least one neighboring base station is a nulling mode in which null data is transmitted to at least one of mobile terminals included in a cell of the serving base station, determine whether a response signal received from the at least one mobile terminal is generated by an interference signal of the at least one neighboring base station, if the beamforming transmit mode of the at least one neighboring base station is the nulling mode, and determine whether to update a backoff factor value based on a result of the determination.

8. The serving base station of claim 7, wherein the controller calculates a first data amount indicating a total amount of data transmitted to the at least one mobile terminal in a first frame period in a first frequency band among multiple frequency bands, calculates a second data amount indicating an amount of data transmitted to the at least one mobile terminal in a fourth frame period, which is an overlapping frame period between a second frame period in which the serving base station transmits data by using the beamforming in the first frequency band and a third frame period in which the at least one neighboring base station transmits data by using the beamforming in the first frequency band, determines a ratio of the second data amount to the first data amount, and determines whether the beamforming transmit mode of the at least one neighboring base station is the nulling mode, according to whether the ratio of the second data amount to the first data amount is greater than a threshold value,
wherein the fourth frame period is included in the first frame period.

9. The serving base station of claim 8, wherein the controller determines that a negative acknowledgement (NACK) signal is generated due to the interference signal of the at least one neighboring base station, if the response signal is the NACK signal corresponding to data transmitted in a fifth frame interval that is the remaining frame interval of the first frame interval except for the fourth frame interval.

10. The serving base station of claim 7, wherein the controller determines not to update the backoff factor value if determining that the response signal is generated by the interference signal of the at least one neighboring base station.

11. The serving base station of claim 7, wherein the controller determines to update the backoff factor value by a preset value corresponding to an acknowledgement (ACK) signal, if the response signal is the ACK signal.

12. The serving base station of claim 7, wherein the beamforming information received from the at least one neighboring base station further comprises a base station identifier (ID) of the at least one neighboring base station.

13. A method for transmitting and receiving beamforming information by a neighboring base station in a mobile communication system, the method comprising:
transmitting to a serving base station, first beamforming information including information about a frame period in which the neighboring base station transmits data by using frequency band-specific beamforming; and
receiving from the serving base station, second beamforming information including information about a frame period in which the serving base station transmits data by using the frequency band-specific beamforming.

14. The method of claim 13, wherein the first beamforming information is transmitted to the serving base station, if a request message requesting provisioning of the first beamforming information is received from the serving base station or at preset intervals.

15. The method of claim 13, wherein the second beamforming information is received from the serving base station, if a request message requesting provisioning of the second beamforming information is transmitted to the serving base station, or at preset intervals.

16. A neighboring base station in a mobile communication system, the neighboring base station comprising:
a base station interface configured to transmit to a serving base station, first beamforming information including information about a frame period in which the neighboring base station transmits data by using frequency band-specific beamforming, and to receive from the serving base station, second beamforming information including information about a frame period in which the serving base station transmits data by using the frequency band-specific beamforming.

17. The neighboring base station of claim 16, wherein the first beamforming information is transmitted to the serving base station, if a request message requesting provisioning of the first beamforming information is received from the serving base station or at preset intervals.

18. The neighboring base station of claim 16, wherein the second beamforming information is received from the serving base station, if a request message requesting provisioning of the second beamforming information is transmitted to the serving base station, or at preset intervals.
